(19) United States
(12) Patent Application Publication
(10) Pub. No.: US 2017/0295421 A1
(43) Pub. Date: Oct. 12, 2017

(54) WIRELESS EARPHONE SET

(71) Applicant: MAVIN TECHNOLOGY INC., Zhubei City (TW)

(72) Inventor: Su-Yu HUNG, Zhubei City (TW)

(73) Assignee: MAVIN TECHNOLOGY INC., Zhubei City (TW)

(21) Appl. No.: 15/484,833

(22) Filed: Apr. 11, 2017

Related U.S. Application Data
(60) Provisional application No. 62/321,389, filed on Apr. 12, 2016.

(51) Int. Cl. H04R 1/10

(52) U.S. Cl. CPC H04R 1/1016; H04R 1/1075; H04R 1/1041; H04R 1/1033; H04R 1/1025; H04R 2420/09; H04R 2201/107

(57) ABSTRACT

A wireless earphone set comprises two earphones and a first cable. Each of the two earphones comprises a housing, a first connector and an internal power source. The first connector is disposed in the housing. The internal power source is disposed in the housing, and electrically connected to the first connector. The first cable has two second connectors at two ends thereof. The second connectors of the first cable are detachably and electrically connected to the first connectors of the two earphones, respectively.

### CROSS-REFERENCE TO RELATED APPLICATIONS

This application claims the priority benefits of U.S. provisional application Ser. No. 62/321,389 filed on Apr. 12, 2016, the entire contents of which are hereby incorporated by reference.

### TECHNICAL FIELD

The disclosure relates to a wireless earphone set, more particularly to a wireless earphone set comprising a detachable transmission cable.

### BACKGROUND

Earphones are electroacoustic transducers, which convert an electrical signal to a corresponding sound to allow users to listen to music or answer phone calls. Generally, earphones include wired earphones and wireless earphones. The wired earphones communicate with other electronic devices (e.g. computers or cell phones) through a cable. On the other hand, the wireless earphones can communicate with other electronic devices in a wireless manner (e.g. via Bluetooth), so that users' freedom of movement is no longer restricted by cables while wearing a wireless earphone. Hence, a wireless earphone is more flexible for exercising or driving.

In detail, conventional wireless earphones may be divided into cable-free type wireless earphone and cable-connected type wireless earphone. The cable-free type wireless earphone may be, for example, a TWS (true wireless stereo) earphone. In a cable-free type wireless earphone set, the right and left earphones are separated from each other, and communicate with each other in a wireless manner. The cable-connected type wireless earphone may be, for example, a regular Bluetooth earphone. In a cable-connected type wireless earphone set, the right and left earphones are inseparably connected to each other by a cable, and communicate with each other through the cable. Both of the two types of wireless earphones have their own advantages; the cable-free type wireless earphone allows users to move more freely, whereas the cable-connected type has lower transmission delay and lower power consumption because the earphones communicate with each other via a cable. However, consumers cannot enjoy both of the advantages from one product. Therefore, how to provide a wireless earphone set with the advantages of more convenience and lower transmission delay is a hot topic in this field.

### SUMMARY

One embodiment of the disclosure provides a wireless earphone set comprising two earphones and a first cable. Each of the two earphones comprises a housing, a first connector and an internal power source. The first connector is disposed in the housing. The internal power source is disposed in the housing, and electrically connected to the first connector. The first cable has two second connectors at two ends thereof. The second connectors of the first cable are detachably and electrically connected to the first connectors of the two earphones, respectively.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a perspective view of a wireless earphone set in accordance with a first embodiment of the disclosure;

FIG. 2 is an exploded view of a first earphone in FIG. 1;

FIG. 3 is a perspective view of a wireless earphone set in accordance with a second embodiment of the disclosure;

FIG. 4 is a perspective view of a third connector in FIG. 3 provided as another example;

FIG. 5 is a perspective view of a wireless earphone set in accordance with a third embodiment of the disclosure; and

FIG. 6 is a perspective view of a wireless earphone set in accordance with a fourth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

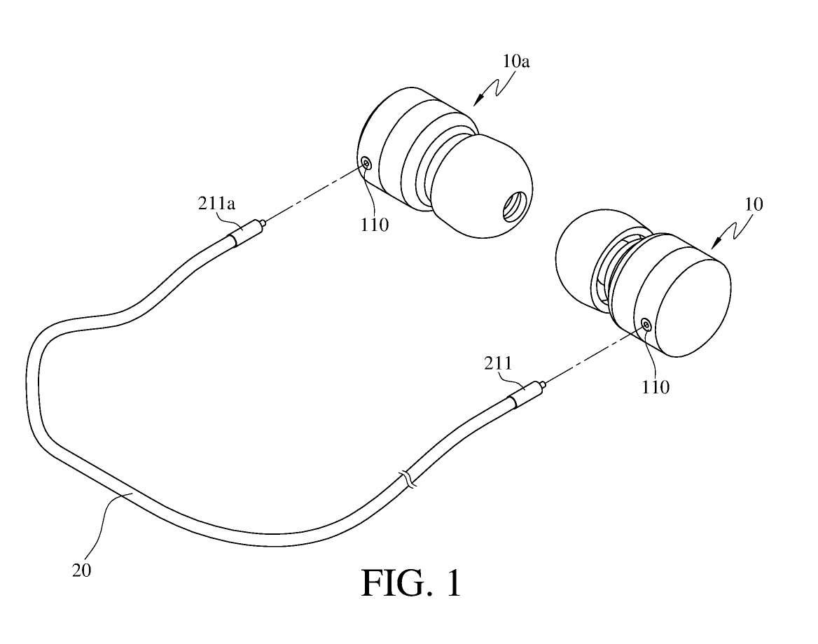

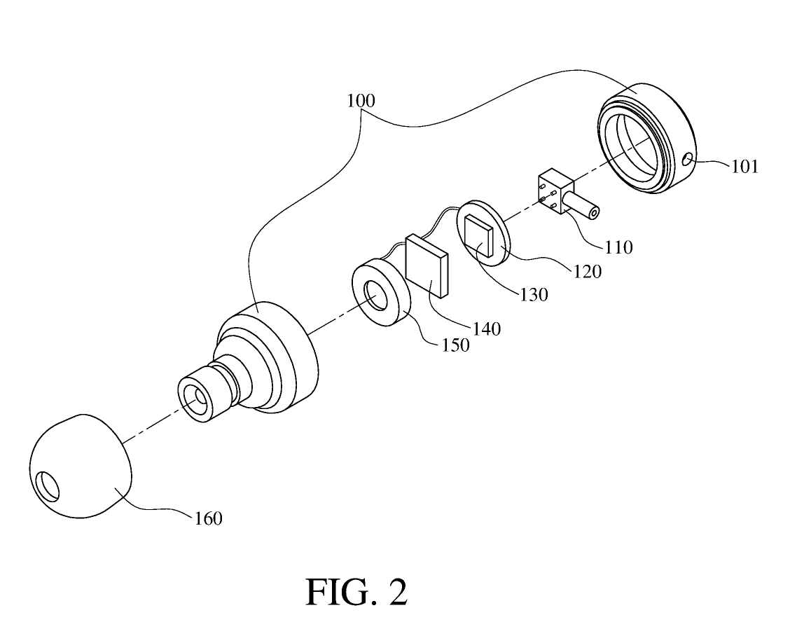

Please refer to FIG. 1 and FIG. 2. FIG. 1 is a perspective view of a wireless earphone set in accordance with a first embodiment of the disclosure. FIG. 2 is an exploded view of a first earphone in FIG. 1.

In this embodiment, a wireless earphone set 1 is provided as an in-ear earphone set. The wireless earphone set 1 includes a first earphone 10, a second earphone 10a and a first cable 20. The first earphone 10 and the second earphone 10a are the same in structure. As shown in FIG. 2, the first earphone 10 and the second earphone 10a each include a housing 100, a first connector 110, a printed circuit board 120, a wireless communication module 130, an internal power source 140, a speaker 150 and an eartip 160.

The housing 100 has an opening 101. The first connector 110 is, for example, a micro-miniature coaxial (MMCX) socket connector. The first connector 110 is disposed in the housing 100. The first connector 110 has a slot connected to an exterior space through the opening 101 of the housing 100. The printed circuit board 120, the wireless communication module 130, the internal power source 140 and the speaker 150 are disposed in the housing 100. In addition, the first connector 110, the wireless communication module 130, the internal power source 140 and the speaker 150 are electrically connected to one another through the printed circuit board 120. The internal power source 140 is configured to provide electric power to the printed circuit board 120, the wireless communication module 130 and the speaker 150. The wireless communication module 130 is configured to communicate with a communication module (not shown) of an external electronic device and transmit audio signals to the speaker 150. The speaker 150 receives the audio signals and converts it into sound. The eartip 160 is disposed on the housing 100 for being fitted into the ear canal.

The first cable 20 has two second connectors 211, 211a at its two ends. The second connectors 211, 211a are, for example, MMCX plug connectors. The second connectors 211, 211a are detachably and electrically connected to the first connectors 110 of the first earphone 10 and the second earphone 10a, respectively.

In this embodiment, the first earphone 10 and the second earphone 10a are configured to be placed inside the ear canal via the eartips 160, but the present disclosure is not limited thereto. In other embodiments, the wireless earphone set may be an ear hanging type earphone set.

Furthermore, in this embodiment, the first connectors 110 are MMCX socket connectors, and the second connectors 211, 211a are MMCX plug connectors, but the present disclosure is not limited thereto. In other embodiments, the first connectors and the second connectors may be 2-pin connectors. Moreover, in other embodiments, the first connectors may be plug connectors, and the second connectors may be socket connectors.

In this embodiment, the first earphone 10 and the second earphone 10a of the wireless earphone set 1 may work independently or incorporate with the first cable 20. Accordingly, there are two modes of using the wireless earphone set 1, one is TWS (true wireless stereo) mode, and the other is Bluetooth mode. In addition, the wireless earphone set 1 may include a detection circuit (not shown) for detecting the connection among the first cable 20, the first earphone 10 and the second earphone 10a for mode switching.

In detail, when the first earphone 10 and the second earphone 10a are not connected to the first cable 20, the wireless earphone set 1 is switched to the TWS mode. In this case, the communication module of the external electronic device (not shown) wirelessly transmits audio signals, including right channel and left channel audio signals, to the wireless communication module 130 of the first earphone 10. When the wireless communication module 130 of the first earphone 10 receives the audio signals, a processor (not shown) on the printed circuit board 120 processes these audio signals and controls the speaker 150 to output left or right channel sound. Then, the first earphone 10 wirelessly transmits the other channel audio signal to the second earphone 10a so that the second earphone 10a can output the other channel sound.

On the other hand, when the first earphone 10 and the second earphone 10a are connected to the first cable 20, the wireless earphone set 1 is switched to the Bluetooth mode. In this case, the communication module of the external electronic device (not shown) wirelessly transmits the audio signals, including right channel and left channel audio signals, to the wireless communication module 130 of the first earphone 10. When the wireless communication module 130 of the first earphone 10 receives the audio signals, the processor (not shown) on the printed circuit board 120 processes these audio signals and controls the speaker 150 to output left or right channel sound. Then, the first earphone 10 transmits the other channel audio signal to the second earphone 10a through the first cable 20 (i.e. in a wired manner) so that the second earphone 10a can output the other channel sound.

According to the wireless earphone set as described above, due to the detachable first cable, the wireless earphone set is able to be switched to TWS mode or Bluetooth mode in accordance with users' needs. For example, the user can switch the wireless earphone set to TWS mode to move more freely and comfortable while listening to music or making phone calls; or, the user can switch the wireless earphone set to the Bluetooth mode to get a lower transmission delay and a lower power consumption. Accordingly, the wireless earphone set of the present disclosure has different modes for different situations making it more enjoyable to use.

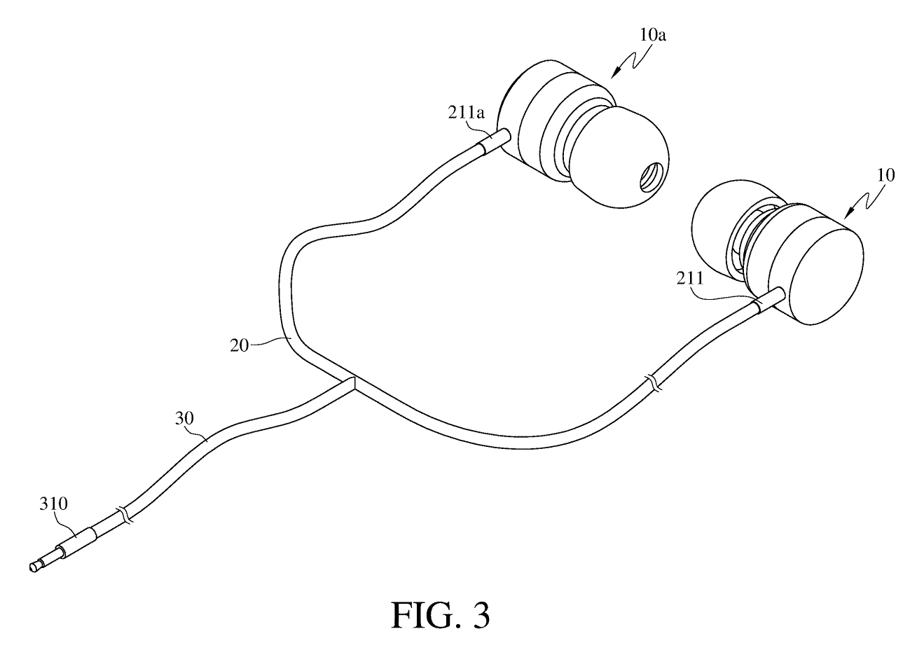

Please refer to FIG. 3, which is a perspective view of a wireless earphone set in accordance with a second embodiment of the disclosure. This embodiment provides a wireless earphone set 2 similar to the wireless earphone set 1 in the first embodiment. The difference between the two embodiments is that the wireless earphone set 2 further includes a second cable 30. The second cable 30 is electrically connected to the first cable 20 at one end thereof, and has a third connector 310 at another end thereof. The third connector 310 is, for example, a 3.5q stereo mini plug. The third connector 310 is configured to be connected to an external electronic device (not shown).

In this embodiment, the wireless earphone set 2 further has a third mode (wired mode). In detail, when the internal power sources 140 of the first earphone 10 and the second earphone 10a are running out of power, the wireless earphone set 2 can be connected to the external electronic device through the second cable 30 so as to extend runtime. In addition, the wireless earphone set 2 may include a detection circuit (not shown) for detecting the connection between the wireless earphone set 2 and the external electronic device for mode switching (i.e. switching between wireless and wired communication modes).

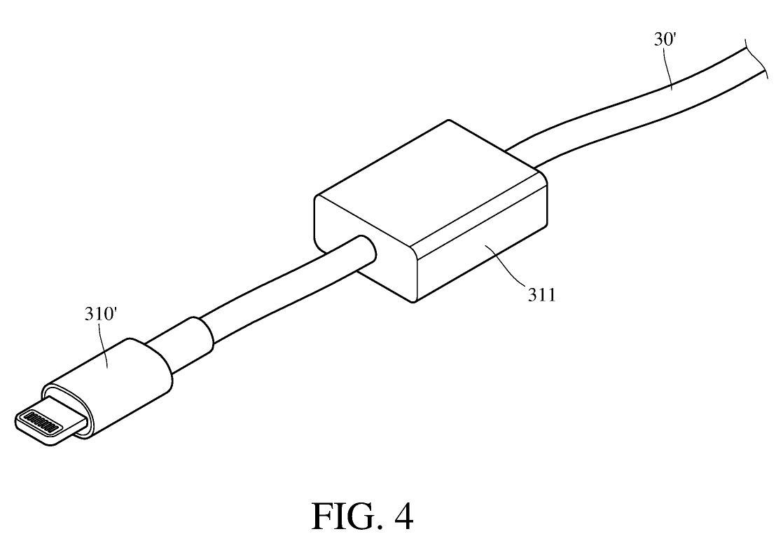

Furthermore, in this embodiment, the third connector 310 of the second cable 30 is a 3.5φ stereo mini plug, but the present disclosure is not limited thereto. In other embodiments, the third connector of the second cable may be a Lightning connector or a USB-C connector. Please refer to FIG. 4, which is a perspective view of a third connector in

FIG. 3 provided as another example. In this example, the third connector 310′ is a Lightning connector. In addition, the second cable 30′ has a control box 311 disposed thereon for converting analog signal and digital signal. When the internal power sources 140 of the first earphone 10 and the second earphone 10a are running out of power, the wireless earphone set 2 can be connected to the external electronic device through the second cable 30′ so as to extend runtime, and in the meantime, the internal power sources 140 of the first earphone 10 and the second earphone 10a are able to be charged by the external electronic device.

According to the wireless earphone set as described in the second embodiment, the wireless earphone set includes the second cable, which is electrically connected to the first cable at one end thereof, and has the third connector at another end thereof to be connected to an external electronic device. When the internal power sources of the first earphone and the second earphone are running out of power, the wireless earphone set can be connected to the external electronic device through the second cable so as to extend runtime, and in the meantime, the internal power sources of the first earphone and the second earphone are able to be charged by the external electronic device. Accordingly, the wireless earphone set is able to work even when the internal power sources are running out of power; furthermore, the wireless earphone set is able to be charged without being taken off from user's ears.

Moreover, when the first earphone and the second earphone are connected to the external electronic device by the first cable and second cable, the wireless earphone set transmits audio signals in a wired manner. Therefore, the synchronization of the signal transmission between external electronic device and the wireless earphone set is improved, and the power consumption of the wireless communication module is reduced because the audio signals are transmitted in a wired manner.

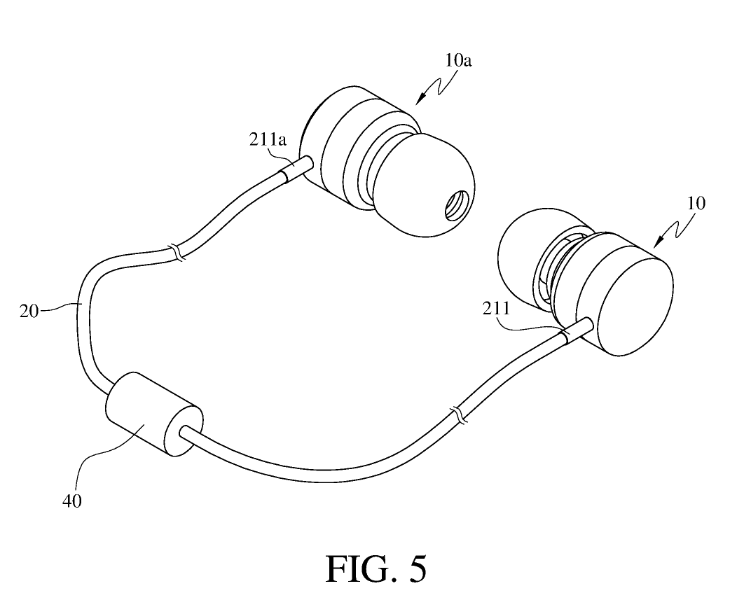

Please refer to FIG. 5, which is a perspective view of a wireless earphone set in accordance with a third embodiment of the disclosure. This embodiment provides a wireless earphone set 3 similar to the wireless earphone set 1 in the first embodiment. The differences between the two embodiments are that: in this embodiment, the wireless earphone set 3 further includes an external power source 40. The first cable 20 includes an electric power transmission line (not shown) and a signal transmission line (not shown). The external power source 40 is electrically connected to the electric power transmission line. The external power source 40 provides electric power to charge the internal power sources 140 of the first earphone 10 and the second earphone 10a through the electric power transmission line, and the first earphone 10 and the second earphone 10a are connected through the signal transmission line of the first cable 20 for signal transmission.

In addition, the external power source 40 of the wireless earphone set 3 of the present disclosure is able to be charged through the first cable connected to another power source, or the external power source may further have a USB-C connector disposed thereon so as to be connected to the another power source for recharging.

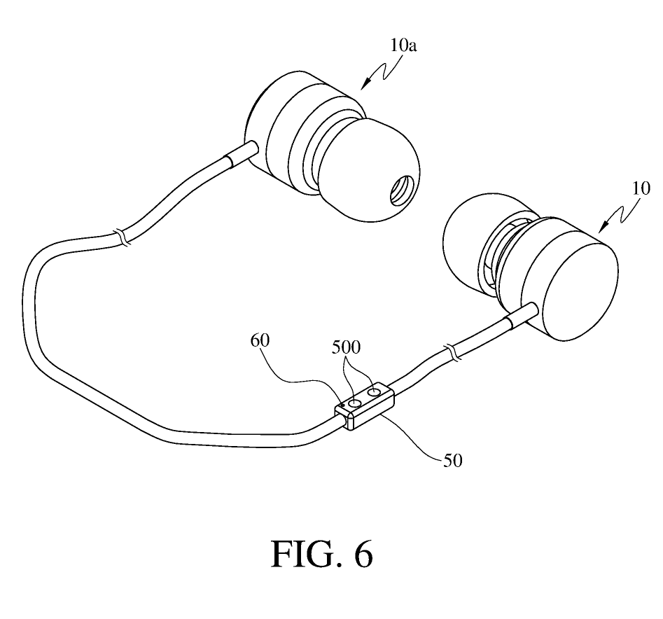

Please refer to FIG. 6, which is a perspective view of a wireless earphone set in accordance with a fourth embodiment of the disclosure. This embodiment provides a wireless earphone set 4 similar to the wireless earphone set 1 in the first embodiment. The differences between the two embodiments are that: in this embodiment, the wireless earphone set 4 further includes a controller 50 and a microphone 60 disposed on the first cable 20. The controller 50 includes two buttons 500 configured to switch functions or adjust volume of the first earphone 10 and the second earphone 10a. The microphone 60 is configured to receive sound. In this embodiment, the controller and the microphone are provided as one unit, but the present disclosure is not limited thereto. In other embodiments, the controller and the microphone may be two separate members respectively disposed on the first cable. Furthermore, in other embodiments, the wireless earphone set may only include the controller without the microphone, or only the microphone without the controller.

In addition, in the embodiments of the present disclosure described above, the first cable 20 and the second cable 30 each may include an electric power transmission line and a signal transmission line. The electric power transmission line includes a charging wire and a positive and negative wire, wherein the charging wire is configured to be connected to an external power supply and transmit power for charging the internal power source, and the positive and negative wire is configured to be connected to the external power supply. The signal transmission line includes an audio signal transmission wire, a control signal transmission wire, a microphone signal wire and a data communication wire, wherein the audio signal transmission wire is configured to transmit audio signals, the control signal transmission wire is configured to transmit control signals from the controller, the microphone signal wire is configured to transmit sound signals received by the microphone, and the data communication wire is configured to transmit signals between the first earphone and the second earphone.

According to the wireless earphone set as described above, due to the detachable first cable, the wireless earphone set is able to be switched to TWS mode or Bluetooth mode in accordance with users' needs. For example, the user can switch the wireless earphone set to TWS mode to move more freely and comfortable while listening to music or making phone calls; or, the user can switch the wireless earphone set to the Bluetooth mode to get a lower transmission delay and a lower power consumption. Accordingly, the wireless earphone set of the present disclosure has different modes for different situations making it more enjoyable to use.

In addition, the wireless earphone set of the present disclosure may include the second cable, which is electrically connected to the first cable at one end thereof, and has the third connector at another end thereof to be connected to an external electronic device. When the internal power sources of the first earphone and the second earphone are running out of power, the wireless earphone set can be connected to the external electronic device through the second cable so as to extend runtime, and in the meantime, the internal power sources of the first earphone and the second earphone are able to be charged by the external electronic device. Accordingly, the wireless earphone set is able to work even when the internal power sources are running out of power; furthermore, the wireless earphone set is able to be charged without being taken off from user's ears.

Moreover, when the first earphone and the second earphone are connected to the external electronic device by the first cable and second cable, the wireless earphone set transmits audio signals in a wired manner. Therefore, the synchronization of the signal transmission between external electronic device and the wireless earphone set is improved, and the power consumption of the wireless communication module is reduced because the audio signals are transmitted in a wired manner.

Furthermore, the wireless earphone set may include an external power source electrically connected to the first cable. When the internal power sources of the first and second earphones are running out of power, the wireless earphone set is able to be connected to the external power source through the first cable so as to extend runtime, and in the meantime, the internal power sources of the first earphone and the second earphone are able to be charged by the external power source. Accordingly, the wireless earphone set is capable of providing a wider range of movement for users and a longer runtime.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

Claims what is claimed is:

1. A wireless earphone set, comprising:
two earphones, each of the two earphones comprising:
a housing;
a first connector, disposed in the housing; and
an internal power source, disposed in the housing, and electrically connected to the first connector; and
a first cable, having two second connectors at two ends thereof, and the second connectors of the first cable detachably and electrically connected to the first connectors of the two earphones, respectively.

2. The wireless earphone set according to claim 1, wherein each of the two earphones further comprises a speaker disposed in the housing, the speaker is electrically connected to the internal power source, and the speaker is configured to output a sound.

3. The wireless earphone set according to claim 2, wherein the two earphones are a first earphone and a second earphone, the first earphone and the second earphone each further comprise a wireless communication module disposed in the housing, the wireless communication module is electrically connected to the internal power source and the speaker; when the second connectors of the first cable are detached from the first connectors of the first earphone and the second earphone, the wireless communication module of the second earphone is configured to communicate with the wireless communication module of the first earphone.

4. The wireless earphone set according to claim 3, further comprising an external power source, wherein the first cable comprises an electric power transmission line and a signal transmission line, the external power source is electrically connected to the electric power transmission line, and the first earphone and the second earphone are connected to each other through the signal transmission line.

5. The wireless earphone set according to claim 3, further comprising a second cable, the second cable electrically connected to the first cable at one end thereof, the second cable having a third connector at another end thereof, and the third connector configured to be connected to an external electronic device.

6. The wireless earphone set according to claim 5, wherein the third connector of the second cable is a 3.5φ stereo mini plug, a Lightning connector or a USB-C connector.

7. The wireless earphone set according to claim 6, wherein the first cable and the second cable each comprise an electric power transmission line and a signal transmission line, the external electronic device provides electric power to charge the internal power sources of the first earphone and the second earphone through the electric power transmission line, and the external electronic device is connected to the first earphone and the second earphone through the signal transmission line for signal transmission.

8. The wireless earphone set according to claim 1, further comprising a controller disposed on the first cable, and the controller configured to switch functions or adjust volume of the two earphones.

9. The wireless earphone set according to claim 8, further comprising a microphone disposed on the first cable.

10. The wireless earphone set according to claim 9, wherein the first cable comprises an electric power transmission line and a signal transmission line, the electric power transmission line comprises a charging wire and a positive and negative wire, wherein the charging wire is configured to be connected to an external power supply and transmit power for charging the internal power source, the positive and negative wire is configured to be connected to the external power supply; the signal transmission line comprises an audio signal transmission wire, a control signal transmission wire, a microphone signal wire and a data communication wire, wherein the audio signal transmission wire is configured to transmit audio signals, the control signal transmission wire is configured to transmit control signals from the controller, the microphone signal wire is configured to transmit sound signals received by the microphone, and the data communication wire is configured to transmit signals between the two earphones.
